(19) United States
(12) Patent Application Publication
(10) Pub. No.: US 2010/0111293 A1
(43) Pub. Date: May 6, 2010

(54) ENCRYPTED FILE WITH HIDDEN CONTENTS

(75) Inventors: Lior Frenkel, Moshav Misgav Dov (IL); Amir Zilberstein, Yad Rambam (IL)

Correspondence Address: D. Kligler I.P. Services LTD, P.O. Box 25, Zippori, 17910, IL

(73) Assignee: GITA TECHNOLOGIES LTD, Rosh Ha'Ayin (IL)

(21) Appl. No.: 12/522,543

(22) PCT Filed: Jan. 17, 2008
(86) PCT No.: PCT/IL08/00075

§ 371 Date: Jul. 9, 2009

(30) Foreign Application Priority Data
Jan. 18, 2007 (IL) 180801

(51) Int. Cl. H04L 9/28

(52) U.S. Cl. 380/28

(57) ABSTRACT

A method for storing data includes encrypting a first file (30) so as to generate a block (32) of encrypted data. The block of the encrypted data is inserted into a second file (34) containing data having a random distribution. The second file, including the block of the encrypted data, is stored in a storage medium (24).

### FIELD OF THE INVENTION

The present invention relates generally to information security, and specifically to devices and methods for enhancing the security of data communications.

### BACKGROUND OF THE INVENTION

Data encryption is widely used in preventing unauthorized access to data. Various methods of data encryption are known in the art. In general, these methods use a key to convert data to a form that is unintelligible to a reader (human or machine), and require an appropriate key in order to decrypt the data. Symmetric encryption methods use the same key for both encryption and decryption. Such symmetric methods include the well-known DES (Data Encryption Standard) and AES (Advanced Encryption Standard) algorithms. In asymmetric encryption methods, such as the RSA (Rivest Shamir Adelman) algorithm, a computer that is to receive encrypted data generates complementary public and private keys. The data are encrypted using the public key, after which only the holder of the private key can decrypt the data.

### SUMMARY OF THE INVENTION

Embodiments of the present invention that are described hereinbelow provide enhanced methods and systems for protecting data security. In such embodiments, a file of data is encrypted, and the resulting block of encrypted data is inserted into another file of data having a random distribution. Typically, the computer file system that is used in storing and retrieving this latter file is unaware of the file contents and thus gives no indication that the file of random data actually contains the encrypted data file. Therefore, an unauthorized user will be unable even to detect the existence of the encrypted data file, let alone decrypt it.

There is therefore provided, in accordance with an embodiment of the present invention, a method for storing data, including:

encrypting a first file so as to generate a block of encrypted data;

inserting the block of the encrypted data into a second file containing data having a random distribution; and

storing the second file, including the block of the encrypted data, in a storage medium.

Typically, encrypting the first file includes randomizing the encrypted data in the block.

In some embodiments, inserting the block includes selecting, using a process of variable selection, a location in the second file at which to insert the block of the encrypted data. Selecting the location may include applying a pseudo-random process in selecting the location. Alternatively or additionally, encrypting the first file may include providing a first key for use in decrypting the first file, while inserting the block includes providing a second key identifying the location of the block of the encrypted data in the second file. In a disclosed embodiment, the second file is retrieved from the storage medium, and the first file is decrypted using the first and second keys.

In some embodiments, encrypting the first file includes generating a first block of first encrypted data, and inserting the block of the encrypted data includes inserting the first block at a first location in the second file, and the method includes encrypting a third file so as to generate a second block of second encrypted data, and inserting the second block at a second location in the second file. The first and second blocks may be generated and inserted using different first and second keys.

Typically the second file is stored using a file system of a host computer, which is coupled to the storage medium, and the file system provides no indication that the second file contains the second file.

There is also provided, in accordance with an embodiment of the present invention, apparatus for storing data, including:

a storage medium; and

an encryption processor, which is configured to encrypt a first file so as to generate a block of encrypted data, and to insert the block of the encrypted data into a second file containing data having a random distribution, and to store the second file, including the block of the encrypted data, in the storage medium.

There is additionally provided, in accordance with an embodiment of the present invention, a computer software product, including a computer-readable medium in which program instructions are stored, which instructions, when read by a computer, cause the computer to encrypt a first file so as to generate a block of encrypted data, and to insert the block of the encrypted data into a second file containing data having a random distribution, and to store the second file, including the block of the encrypted data, in a storage medium.

The present invention will be more fully understood from the following detailed description of the embodiments thereof, taken together with the drawings in which:

### BRIEF DESCRIPTION OF THE DRAWINGS

FIG. 1 is a schematic, pictorial illustration showing a system for data storage, in accordance with an embodiment of the present invention; and

FIGS. 2A-2D are schematic representations of data files at successive stages in a process of data encryption and concealment, in accordance with an embodiment of the present invention.

### DETAILED DESCRIPTION OF EMBODIMENTS

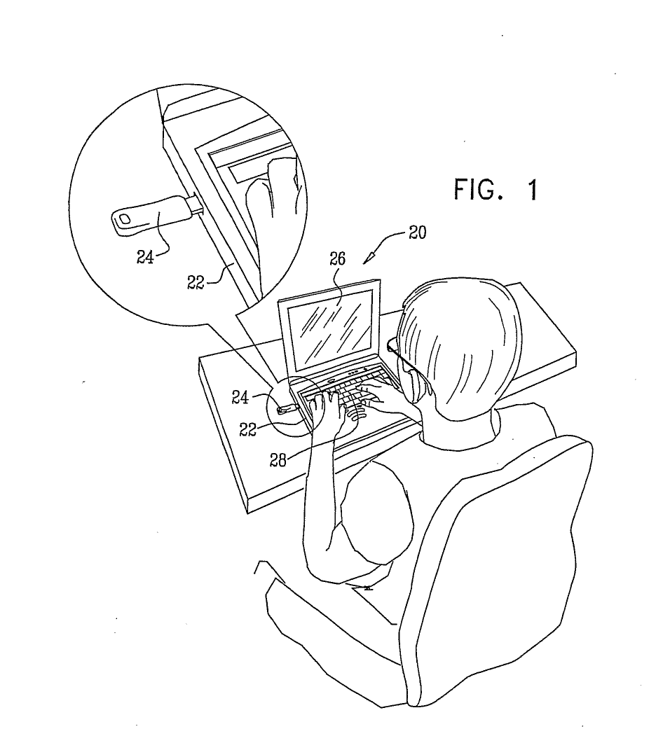

FIG. 1 is a schematic, pictorial illustration of a system 20 for data storage, in accordance with an embodiment of the present invention. System 20 comprises an encryption processor 22, typically in the form of a general-purpose host computer, with suitable user-interface components, such as a display 26 and keyboard 28. The computer stores and retrieves data files to and from a storage medium 24. In the example shown in FIG. 1 and in some of the applications described hereinbelow, the storage medium comprises a disk-on-key, which is readily removable and portable. The principles of the present invention may equally be applied, however, to other types of storage media, including both other removable media (such as CD-ROM, for example), and fixed media (such as a magnetic hard disk drive).

Processor 22 typically performs the functions that are described herein under the control of software. For example, the processor may run an operating system, including a file system used in storing and retrieving data files, along with an application or utility program for purposes of data encryption and concealment. This software may be downloaded to processor 22 in electronic form, over a network, for instance. Additionally or alternatively, the software may be provided on tangible media such as optical, magnetic or electronic data storage media. Further additionally or alternatively, some or all of the encryption- and decryption-related functions of processor 22 may be carried out by dedicated or programmable hardware circuits.

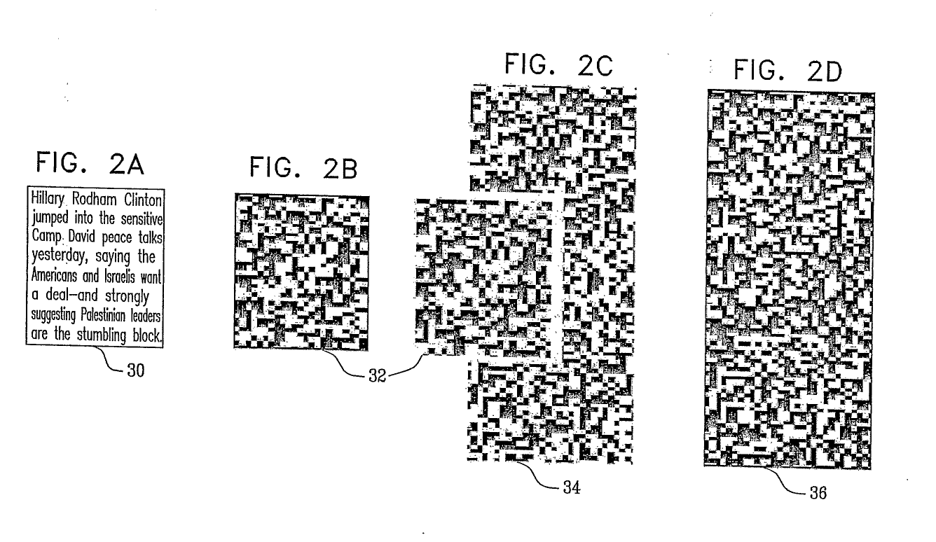

Reference is now made to FIGS. 2A-2D, which schematically represent data files at successive stages in a process of data encryption and concealment, in accordance with an embodiment of the present invention. FIG. 2A shows a data file 30, which a user of processor 22 has created or received, and which is to be stored securely in medium 24. Processor 22 applies an encryption program to file 30, resulting in a block 32 of encrypted data, as shown in FIG. 2B. Any suitable encryption method may be used for this purpose, including both symmetric and asymmetric algorithms. A useful feature of advanced encryption algorithms, such as AES, in the present context is that they mix the data in the course of the encryption process, so that the resulting encrypted data has the appearance of randomized data. The encryption program uses a certain encryption key in encrypting the data in block 32, and a suitable decryption key is provided (either by the user or by the program) for subsequent use in decrypting the data.

Processor 22 inserts encrypted data block 32 into a file 34 containing data having a random distribution, as illustrated in FIG. 2C. In the context of the present patent application and in the claims, the term “random” is used broadly to refer to any block of data that lacks a discernable deterministic pattern. The randomly-distributed data in file 34 may comprise, for example, the output of a pseudo-random number or character generator. As another example, the randomly-distributed data may be produced by encrypting arbitrary data, possibly using the same encryption algorithm as is used to encrypt the data in block 32. Generally speaking, it is desirable that the encryption algorithm used in generating block 32 and the method used in generating the data in file 34 be such that there is no readily-discernable difference between the patterns of the data in block 32 and in file 34. Consequently, after block 32 has been inserted into file 34, it will be difficult or impossible for an unauthorized party to determine the location of the block of encrypted data within the file, or even to know that the file contains a block of encrypted data. The result of this process is a single file 36, as shown in FIG. 2D, containing what appears to be homogeneous random data.

Typically, the location of block 32 within file 36 is variable, i.e., successive instances of the data encryption and concealment process performed by processor 22 will place encrypted data blocks at different locations within the respective files. This variability makes it yet more difficult for unauthorized parties to find and decrypt the data. The location of the block may be chosen by the user, or it may alternatively be chosen by processor 22, typically in a pseudo-random process. A second key, identifying the location of block 32 in file 36, is provided either by the user or by the encryption and concealment program on processor 22. To retrieve the stored data subsequently, the user will typically have to provide two keys: one identifying the location of block 32 and the other for decrypting the block.

Any suitable method may be used to insert block 32 into file 34 at the appropriate location. For example, the randomly-distributed data in block 32 may be created in advance, and processor 22 may then overwrite or otherwise displace the data in file 34 starting from an offset that corresponds to the chosen location. As another example, after generating block 32, the processor may fill file 36 with randomly-distributed data before and after block 32. The order of the operations is immaterial to the present invention.

Optionally, multiple encrypted data blocks may be inserted into file 34 at different, respective, locations. The maximum size and number of such encrypted data blocks to be stored in the file may be preset or, alternatively, configured by the user. Each block may have its own location and encryption keys, so that upon data retrieval from medium 24, only the desired data file is extracted and decrypted, while the other encrypted data block or blocks remain concealed. In this manner, the same file may be used to store confidential data belonging to different users, wherein each user is able to access only his or her own data. As another example, a single user may store multiple encrypted data files within file 36 for presentation to other parties. When the user wishes to open one of the encrypted data files, even on a computer belonging another party, only the desired file will be extracted and encrypted, while the other party remains unaware that the other encrypted files even exist.

As noted earlier, file 36 is typically created by an application or utility program running on processor 22, and it is then stored using the computer file system. File 36 appears to the file system to be a single data file of a given size, without internal structure. As a result, the file system gives no indication that file 36 contains data file 30 or encrypted data block 32. In other words, the directory of medium 24 that is provided by the file system will show no more than the existence and size of file 36 (and other metadata regarding file 36 as a whole).

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for storing data, comprising:
encrypting a first file so as to generate a block of encrypted data;
inserting the block of the encrypted data into a second file containing data having a random distribution; and
storing the second file, including the block of the encrypted data, in a storage medium.

2. The method according to claim 1, wherein encrypting the first file comprises randomizing the encrypted data in the block.

3. The method according to claim 1, wherein inserting the block comprises selecting, using a process of variable selection, a location in the second file at which to insert the block of the encrypted data.

4. The method according to claim 3, wherein selecting the location comprises applying a pseudo-random process in selecting the location.

5. The method according to claim 3, wherein encrypting the first file comprises providing a first key for use in decrypting the first file, and wherein inserting the block comprises providing a second key identifying the location of the block of the encrypted data in the second file.

6. The method according to claim 5, and comprising retrieving the second file from the storage medium, and decrypting the first file using the first and second keys.

7. The method according to claim 1, wherein encrypting the first file comprises generating a first block of first encrypted data, and wherein inserting the block of the encrypted data comprises inserting the first block at a first location in the second file, and wherein the method comprises encrypting a third file so as to generate a second block of second encrypted data, and inserting the second block at a second location in the second file.

8. The method according to claim 7, wherein the first and second blocks are generated and inserted using different first and second keys.

9. The method according to claim 1, wherein the second file is stored using a file system of a host computer, which is coupled to the storage medium, and wherein the file system provides no indication that the second file contains the second file.

10. Apparatus for storing data, comprising:
a storage medium; and
an encryption processor, which is configured to encrypt a first file so as to generate a block of encrypted data, and to insert the block of the encrypted data into a second file containing data having a random distribution, and to store the second file, including the block of the encrypted data, in the storage medium.

11. (canceled)

12. The apparatus according to claim 10, wherein the processor is configured to select, using a process of variable selection, a location in the second file at which to insert the block of the encrypted data.

13-18. (canceled)

19. A computer software product, comprising a computer-readable medium in which program instructions are stored, which instructions, when read by a computer, cause the computer to encrypt a first file so as to generate a block of encrypted data, and to insert the block of the encrypted data into a second file containing data having a random distribution, and to store the second file, including the block of the encrypted data, in a storage medium.

20. The product according to claim 19, wherein the encrypted data in the block are randomized.

21. The product according to claim 19, wherein the instructions cause the computer to select, using a process of variable selection, a location in the second file at which to insert the block of the encrypted data.

22. The product according to claim 21, wherein the instructions cause the computer to apply a pseudo-random process in selecting the location.

23. The product according to claim 21, wherein a first key is provided for use in decrypting the first file, and wherein the instructions cause the computer to provide a second key identifying the location of the block of the encrypted data in the second file.

24. The product according to claim 23, wherein the instructions cause the computer to retrieve the second file from the storage medium, and to decrypt the first file using the first and second keys.

25. The product according to claim 19, wherein encrypting the first file generates a first block of first encrypted data, which is inserted at a first location in the second file, and
wherein the instructions cause the computer to encrypt a third file so as to generate a second block of second encrypted data, and to insert the second block at a second location in the first file.

26. The product according to claim 25, wherein the first and second blocks are generated and inserted using different first and second keys.

27. The product according to claim 19, the second file using a file system, and wherein the file system provides no indication that the first file contains the second file.
